(19) United States
(12) Patent Application Publication
(10) Pub. No.: US 2026/0065880 A1
(43) Pub. Date: Mar. 5, 2026

(54) Ring Holder for a Guitar Pick

(71) Applicant: Douglas Henry Plotzke, Roselle, IL (US)

(72) Inventor: Douglas Henry Plotzke, Roselle, IL (US)

(21) Appl. No.: 19/085,547

(22) Filed: Mar. 20, 2025

Related U.S. Application Data
(60) Provisional application No. 63/689,518, filed on Aug. 30, 2024.

(51) Int. Cl. G10D 3/173; A44C 9/00

(52) U.S. Cl. CPC G10D 3/173; A44C 9/0061

(57) ABSTRACT

The present invention is a ring holder for a guitar pick, comprising a flexible ring, an anchor with a hole, and a chain, rope, or string connecting the ring to a guitar pick. The ring is made from materials such as silicone and is available in various sizes to ensure a comfortable fit for different users. The guitar pick includes a hole near the top, allowing it to be connected to the ring via the chain, rope, or string. This prevents the pick from being dropped while in use and allows the user to easily switch between strumming with the pick and strumming with fingers.

The current application claims a priority to the U.S. Provisional Patent application Ser. No. 63/689,518 filed on Aug. 30, 2024.

### FIELD OF THE INVENTION

The present invention relates generally to musical accessories. More specifically, the present invention relates to a guitar pick attached to a ring worn by the user.

### BACKGROUND OF THE INVENTION

Guitarists of any skill and experience level may occasionally drop their pick while playing. Beginners who are not used to playing may have the pick slip from their fingers, and even professional guitarists may drop a pick while playing quickly or for an extended period. Professionals often have multiple picks on them while playing in case they lose one.

The present invention provides a solution to this problem by attaching a guitar pick to a ring worn on the user's finger. If the user loses control of the pick while playing, the present invention will prevent it from falling to the ground, and the user may simply grab it again. Users may also intentionally release the pick to strum with their fingers, and then grab the pick again to return to strumming with the pick.

### SUMMARY OF THE INVENTION

The present invention is a ring holder for a guitar pick, comprising a ring, a pick, and a chain that attaches the ring to the pick. The user places the ring around their finger to prevent the pick from being dropped while playing.

### BRIEF DESCRIPTION OF THE DRAWINGS

FIG. 1 is a view of the present invention.

FIG. 2 is a view of the ring portion of the present invention.

FIG. 3 is a chain used in the preferred embodiment of the present invention.

FIG. 4 is a pick used in an embodiment of the present invention.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, while many aspects and features relate to, and are described in the context of a ring holder for a guitar pick, embodiments of the present disclosure are not limited to use only in this context

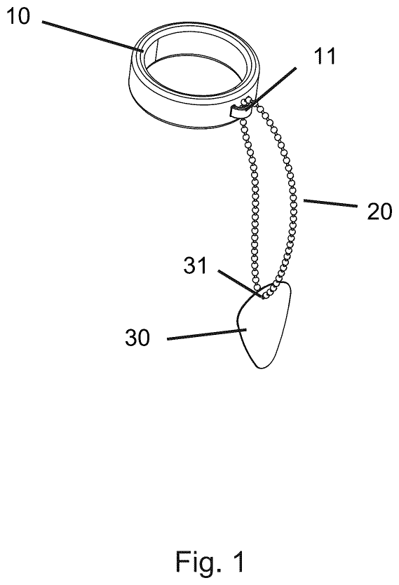

The present invention is a ring holder for a guitar pick comprising a ring 10, a pick 30, and a chain 20. Alternative embodiments may comprise a rope or string rather than a chain. FIG. 1 shows the present invention.

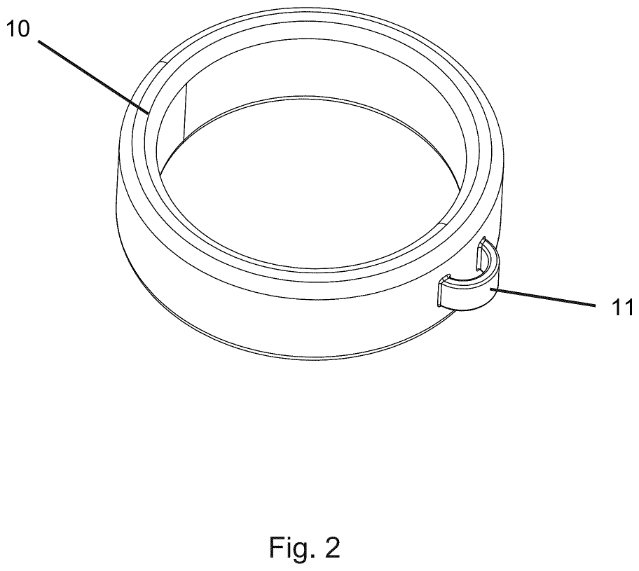

In a preferred embodiment, the ring 10 is made from silicone to allow flexibility. Other materials may also be used. The ring 10 may be manufactured in different sizes to accommodate varying ring sizes of different users. The flexible material of the ring 10 ensures a comfortable fit for any user. The ring 10 further comprises an anchor 11 extending outward from the ring 10, as shown in FIG. 2. Said anchor 11 has a hole through which a chain 20 may be connected.

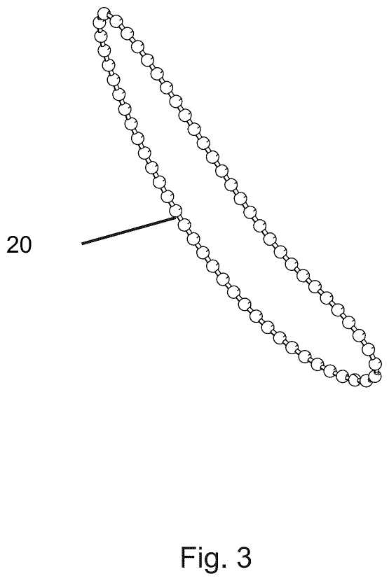

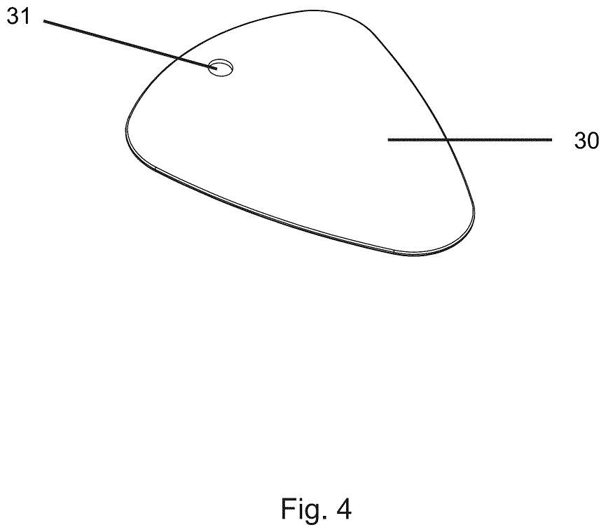

In a preferred embodiment, the ring 10 connects to the pick 30 via a ball chain 20. Said chain 20 is preferably 3¾ inches in length and has a diameter of 2.4 mm. Other dimensions are further contemplated and should be considered within the scope of the present invention. Rope, string, or similar materials may also be used. FIG. 3 shows a chain 20 that may be used in the present invention. The pick 30 of the present invention is functionally similar to existing guitar picks. Unlike common guitar picks, the pick 30 of the present invention comprises a hole 31 near the top, as shown in FIG. 4. The hole 31 may be drilled into a pick, or picks may be manufactured with the hole 31. The chain 20 is placed through the hole 31 in the pick 30 and the hole in the anchor 11 of the ring 10, connecting the two components as shown in FIG. 1. This allows the user to wear the ring 10 and have the pick 30 hanging in their hand where it can be easily grabbed. FIG. 1 shows the pick 30 hanging from the chain 20, which prevents the pick 30 from being dropped while in use. If the user does not wish to use the pick 30, they may move the pick 30 to the back of the hand. This allows the pick 30 to be out of the way when strumming with fingers, but it also allows the user to easily grab the pick 30 again when needed.

The present invention allows any user to play the guitar and not drop the pick 30. The present invention fits comfortably around the finger and keeps the pick 30 easily accessible, whether the user is playing with the pick 30, loses their grip on the pick 30, or wishes to switch between strumming with the pick 30 and strumming with their fingers.

Although the invention has been explained in relation to its preferred embodiment, it is to be understood that many other possible modifications and variations can be made without departing from the spirit and scope of the invention.

What is claimed is:

1. A ring holder for a guitar pick comprising,
a ring;
a pick; and
a chain;
the ring further comprising an anchor extending outward from the ring through which the chain may be threaded; and
the pick further comprising a hole, wherein the chain is further threaded through said hole connecting the ring to the pick

2. The ring holder for a guitar pick of claim 1, wherein the ring is made of flexible material.

3. The ring holder for a guitar pick of claim 1, wherein the chain is a ball chain, string, rope, or similar means allowing the pick to connect to and hang from the ring

4. The ring holder for a guitar pick of claim 1, wherein the chain allows the pick to hang from the ring while in use to prevent a user from dropping the pick, and wherein the user may rest the pick on the back of the hand when not in use, allowing the user to strum with the fingers and easily grab the pick again when needed.
